(19) United States
(12) Patent Application Publication
(10) Pub. No.: US 2010/0089878 A1
(43) Pub. Date: Apr. 15, 2010

(54) CUTTING DEVICE

(75) Inventor: Peter Halser, St. Gallen (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: NUM INDUSTRY ALLIANCE AG, Teufen (CH)

(21) Appl. No.: 12/576,460

(22) Filed: Oct. 9, 2009

(30) Foreign Application Priority Data
Oct. 10, 2008 (DE) 102008050939.6
Nov. 22, 2008 (DE) 102008058644.7-26
Sep. 9, 2009 (EP) 09011523.9

(51) Int. Cl. B23K 9/00; B23K 26/14; B26F 3/00; B26D 7/26; G05B 15/00

(52) U.S. Cl. 219/121.39; 219/121.67; 83/177; 83/699.51; 700/275

(57) ABSTRACT

A cutting device (1) having a cutting head (2) suspended pivotally in an articulate suspension (10) that includes two intersecting or skew rotary axes (4) and (5.) Two actuators (6, 7) are displaceable along linear axes (8) and (9) preferably aligned horizontally or vertically or diagonally, and engage the cutting head (2) via rods (13) and (14). The pivotal movements can be executed and controlled around the axes (4) and (5) by the linear adjustment motions of the actuators (6) and (7.) The cutting head (2) has a plasma cutter (19) and/or a laser cutter and/or a jet cutter and/or a mechanical cutter.

### CROSS-REFERENCE TO RELATED APPLICATIONS

This application claims the benefit of German Patent Application No. DE 10 2008 050 939.6, filed Oct. 10, 2008; German Patent Application No. DE 10 2008 058 644.7-26, filed Nov. 22, 2008 and European Patent Application No. EP 09011523.9, filed Sep. 9, 2009, all of which are incorporated herein by reference as if fully set forth.

### BACKGROUND

The invention relates to a cutting device, particularly for cutting work pieces, having a cutting head freely pivotal within a dihedral angle range and a control device, by which the alignment of the operating direction of the cutting head can be adjusted within the dihedral angle range.

Further, the invention relates to a method for controlling such a cutting device.

Such cutting devices are known and have proven in the production of arbitrary “two-dimensional”, planar, and/or three-dimensional work pieces. Here, it is common to provide the mobility of the cutting head within the dihedral angle range by way of rotary drives, by which rotary motions can be performed around two independent rotary axes, particularly arranged perpendicularly in reference to each other. These rotary motions can be combined to arbitrary motions in order to allow an arbitrary pivoting of the cutting head within the dihedral angle range. Simple designs of cutting devices develop when drives directly drive the axes of the rotary motions.

### SUMMARY

The invention is based on the object to provide a cutting device allowing rapid movements of the cutting head.

In order to attain this object it is provided in a cutting device of the type mentioned at the outset that the cutting head is suspended in a pivotal fashion, with the pivoting being executable around axes crossing each other or extending skew in reference to each other, and that the control device comprises at least two actuators that can be operated independently from each other, with each of them being displaceable along a linear axis and respectively engaging the cutting head for pivoting said cutting head.

In this document a linear axis is understood as a one-dimensional guide, which can be embodied curved or straight. Here, it is advantageous for the invention that a rotary drive can be omitted, which results in the requirements concerning stability and stress resistance of the cable guides for the drives to be more advantageous and less expensive. Two axes are skew when they are not aligned parallel in reference to each other and when their extensions fail to intersect. By the implementation of pivotal motions of the cutting head in the form of linear movements along the linear axis it is beneficially achieved that by this construction the movements can be easily decoupled from each other into different levels of freedom or directions. This allows avoiding a simultaneous movement of one drive in a direction of motion due to the movement of a second drive in another direction of movement, as is mandatory in direct rotary drives around two rotary axes, for example. The mobility of the cutting head is therefore less inertial because a lower weight must be entrained, resulting in a reduction of the moment of inertia.

In an advantageous embodiment of the invention it may be provided for the cutting head to be suspended in a classical and/or in a common link, for example a Cardan joint. Here, it is advantageous that a simple guide of the movements of the cutting head is possible. Particularly the use of a Cardan joint provides the freedom of movement necessary for a cutting head. However, modifications of a Cardan joint can also be used advantageously, allowing rotations around two axes, or perhaps a suspension using a ball-and-socket joint.

By the arrangement of the pivotal axes a joint can be used, comprising exactly two independent freedom-levels of movement only, allowing the cutting device to operate with precisely two independently operating actuators, in order to adjust arbitrary, pivotal alignments of the cutting head within an accessible dihedral angle.

In an advantageous embodiment of the invention it may be provided that the linear axes extend in a straight fashion. Here, it is beneficial that both the drive of the control device as well as the guide and the control can be embodied axis in a particularly simple fashion along a linear. Then, the stress of the guide elements and thus the wear and tear of the material can be kept low or minimized.

A small amount of space necessary for the cutting device results when the linear axes of the actuators are aligned parallel in reference to each other, particularly aligned to each other or side-by-side, and/or diagonally.

For example, here it may be provided that the linear axes are arranged in a common plane and thus describe said plane.

In order to operate the cutting device it may be provided that the plane, described by the axes of the suspension of the cutting head, is aligned horizontally in the operational position of the cutting device. The cutting device may also be used in other orientations, though, with the plane described by the axes of the suspension of the cutting head extending preferably parallel in reference to the operating area and/or receiving area and/or support area for a work piece to be processed by the cutting head.

For example, the linear axes may be aligned horizontally. A support area for the cutting device as small as possible is achieved, though, when in the operating position of the cutting device the linear axes each enclose an angle with a horizontal plane. Preferably, it may be provided for the linear axes to be aligned vertically in the operating position of the cutting device. The linear axes thus enclose a right angle with a horizontal plane.

For example, it may be provided that in its central position with regard to its pivotal range the linear axes are aligned at an acute angle or parallel in reference to the operating direction of the cutting head and/or that the linear axes are aligned in an acute angle or parallel in reference to the central axis of the dihedral angle range.

A cutting device requiring little space only develops when the cutting head is suspended in a preferably fork-shaped receiver, which projects preferably at a right angle from the plane described by the linear axes. The point of suspension of the cutting head is therefore laterally off-set in reference to the adjustment paths of the actuators, allowing the achievement advantageous geometric conditions.

In order to perform the adjustment motion at the control device, by which the alignment of the cutting head is controlled, it may be provided that each actuator comprises a slide that can be displaced along the linear axis.

According to an embodiment having a robust and simple construction it can be provided that each slide is connected to the cutting head via rods. The embodiment of rods linked to the cutting head and the slides allows for the necessary mobility of the cutting head and simultaneously causes a defined alignment of the cutting head by the control devices.

Preferably the rods are embodied as passive rods, with passive rods representing rods having a predetermined, fixed length, with this length not changing during operation.

In an advantageous embodiment of the invention it may be provided for each of the actuators to comprise an electric drive. The actuators are therefore rapidly and precisely displaceable, and this way the alignment of the cutting head can be automatically adjusted to any position in a fast and precise manner. Another advantage is the fact that the electric drives can be supplied via cables having a fixed cable guide, because the individual axes are decoupled from each other. This way, cable breaks are avoided, which result from a permanent mechanical stress due to the entrainment of the drives.

In an advantageous embodiment of the invention it may be provided that the cutting head comprises at least one means for plasma cutting, laser cutting, jet cutting, and/or mechanical cutting. The cutting head is therefore equipped to perform one of the above-mentioned separating methods or to perform a combination of these separating methods. For these combinations, two, three, or more means of the above-mentioned methods can be integrated in the cutting head.

In an advantageous embodiment of the invention it may be provided that a control unit is implemented, embodied to calculate a position of displacement of the control device for a predetermined angular alignment of the cutting head within a predetermined dihedral angle range. This way the control device and thus the operating direction of the cutting head can be controlled electronically and automatically. The operating direction of the cutting head is determined by the orientation of the means active during the separating or cutting method, i.e. the emission of laser radiation, a plasma beam, or a jet, or the mechanical blade in reference to the pivotal axes or the tip of the opening angle of the dihedral angle range.

In an advantageous embodiment of the invention it may be provided that the opening angle of the dihedral angle range amounts to at least 90°. Preferably the opening angle is selected amounting to 94° or 96° or even greater. The opening angle may be determined, for example, by the displacement path of the actuators available or by the geometry of the suspension.

In an advantageous embodiment of the invention it may be provided that in its idle position the cutting head is arranged in the central axis of the opening angle. This way, the cutting head and its operating direction can be symmetrically deflected, out of its idle position defined by the central axis of the opening angle, by the same angular amount in both directions and this can occur in each virtual plane extending through the central axis. This way, except for the size of the opening angle, there are no limitations to the operating direction of the cutting head, and work pieces can be produced having practically any arbitrary shape. Preferably the axes of the suspension extend perpendicularly in reference to the virtual central axis of the dihedral angle range. When the suspension is embodied in the form of a Cardan joint or generally with two pivotal axes, the axes of the suspension are preferably positioned perpendicularly in reference to each other.

In an advantageous embodiment of the invention it may be provided that a pivoting of the cutting head around a first axis of the suspension of the cutting head can be performed by an opposite displacement of the actuator. This way, an elementary movement of the cutting head can be performed by a simple technically controlled movement of the actuators. Another advantage is the fact that the recoils of the displacement of the actuators can be at least partially compensated by an opposite displacement of the actuators. In the opposite displacement an actuator can be displaced by a displacement path within a period of time which is different from the displacement path of the other actuator within this same period of time and points in the opposite direction, thus the actuators can be displaced by displacement paths different in their amounts, in order to cause the desired pivotal movement of the cutting head. In the opposite displacement, the actuators can also be displaced in opposite directions by the same displacement path, in order to allow the desired pivotal motion of the cutting head.

In an advantageous embodiment of the invention it may be provided that a pivoting of the cutting head around a second axis of the suspension of the cutting head can be performed by an opposite displacement of the actuators. This way, another elementary movement of the cutting head can be performed by another movement of the actuators, easily controlled by technology. In the opposite displacement, an actuator can be displaced by a displacement path over a period of time, which is different from the displacement path of the other actuator during the same period of time and points in the same direction, ergo the actuators can be displaced by different displacement paths in order to cause a desired pivotal motion of the cutting head. During the opposite displacement, the actuators can also be displaced by respectively identical displacement paths, pointing in the same direction, in order to achieve the desired pivotal motion of the cutting head.

More complex movements of the cutting head can be combined from these elementary movements.

During the pivoting of the cutting head, the head may be in operation, i.e. performing a separating or cutting process. Alternatively or additionally it may be provided that the cutting head is operated at the end points of the pivotal motion.

A compact design of the cutting device is achieved when the suspension of the cutting head is connected in a fixed manner to a mounting of the control device. Forces impinging the cutting head during the displacement of the actuators can be compensated by this connection.

In an advantageous embodiment of the invention it may be provided for the suspension of the cutting head to be displaceable with regards to a receiver for the work piece, particularly displaceable within a virtual plane. Here, it is advantageous for the dimensions of the produced work pieces and/or the processed blank or semi-finished product not to be limited by the opening angle of the maximal range of motion and the effective radius of the cutting head.

In order to attain the object in a method according to the invention for controlling a cutting device, it is provided that two actuators that can be operated independently from each other can each be displaced along a linear axis to perform a pivoting of the cutting head. Therefore, linear actuators can be used to align the cutting head, allowing a fast displacement and thus a fast alignment of the cutting head.

Preferably it can be provided that the displacement position on the respective linear axis of the control devices is calculated in a computing device or computer for a predetermined angular alignment of the cutting head within the dihedral angle range.

In an advantageous embodiment of the method, it may be provided that the connection between the displacement path of the actuator and the resulting pivotal angle of the cutting head not being a linear one. Here it is advantageous that special mechanical devices can be avoided that transfer the presently set angle at the cutting head into an adjustment position proportionally illustrating the angle. Rather, the equivalence of the angle and the adjustment position resulting from the geometric features of the connection between the actuators and the cutting head can be used in a control device, stored as a mathematical model and useful for controlling the cutting head.

### BRIEF DESCRIPTION OF THE DRAWINGS

The invention is now explained in greater detail using an exemplary embodiment, however it is not limited to this exemplary embodiment. Additional exemplary embodiments would be understood by a person skilled in the art by combining features of the exemplary embodiment with each other or with the features of the claims.

Shown are:

FIG. 1 is a three-dimensional view of a cutting device according to the invention,

FIG. 2 is a side view of the cutting device according to FIG. 1,

FIG. 3 is a front view of the cutting device according to FIG. 1,

FIG. 4 is a view from the top of the cutting device according to FIG. 1,

FIG. 5 is a three-dimensional view of the cutting device according to FIG. 1 in another operating position,

FIG. 6 is a side view of the cutting device according to FIG. 5,

FIG. 7 is a front view of the cutting device according to FIG. 5,

FIG. 8 is a view from the top of the cutting device according to FIG. 5,

FIG. 9 is a three-dimensional view of the cutting device according to FIG. 1 in a third operating position,

FIG. 10 is a side view of the cutting device according to FIG. 9,

FIG. 11 is a front view of the cutting device according to FIG. 9,

FIG. 12 is a view from the top of the cutting device according to FIG. 9,

FIG. 13 is a three-dimensional view of the cutting device according to FIG. 1 in a fourth operating position,

FIG. 14 is a side view of the cutting device according to FIG. 13,

FIG. 15 is a front view of the cutting device according to FIG. 13,

FIG. 16 is a view from the top of the cutting device according to FIG. 13,

FIG. 17 is a three-dimensional view of the cutting device according to FIG. 1 in a fifth operating position, and

FIG. 18 is a three-dimensional side view of another cutting device according to the invention.

### DETAILED DESCRIPTION OF THE PREFERRED EMBODIMENTS

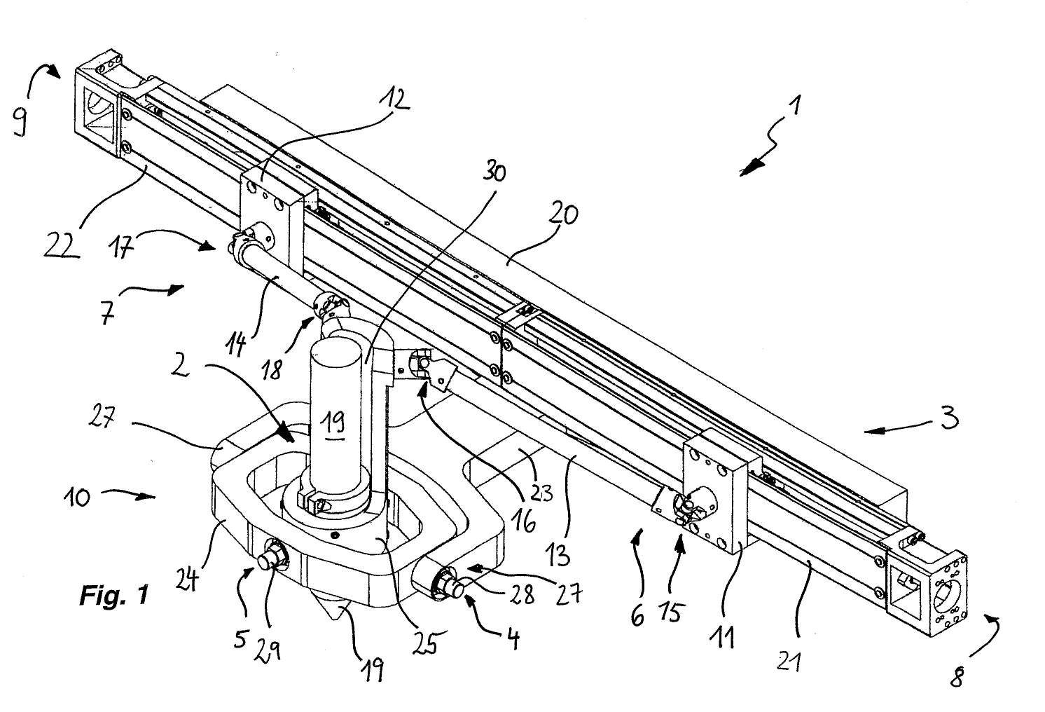

FIG. 1 shows a cutting device, in its entirety marked 1, in a three-dimensional side view, with the other parts, such as the work piece receiver and/or tool bench and mounting frame of the cutting machine to accept the cutting device 1 being omitted for better clarity. They are embodied in a conventional fashion.

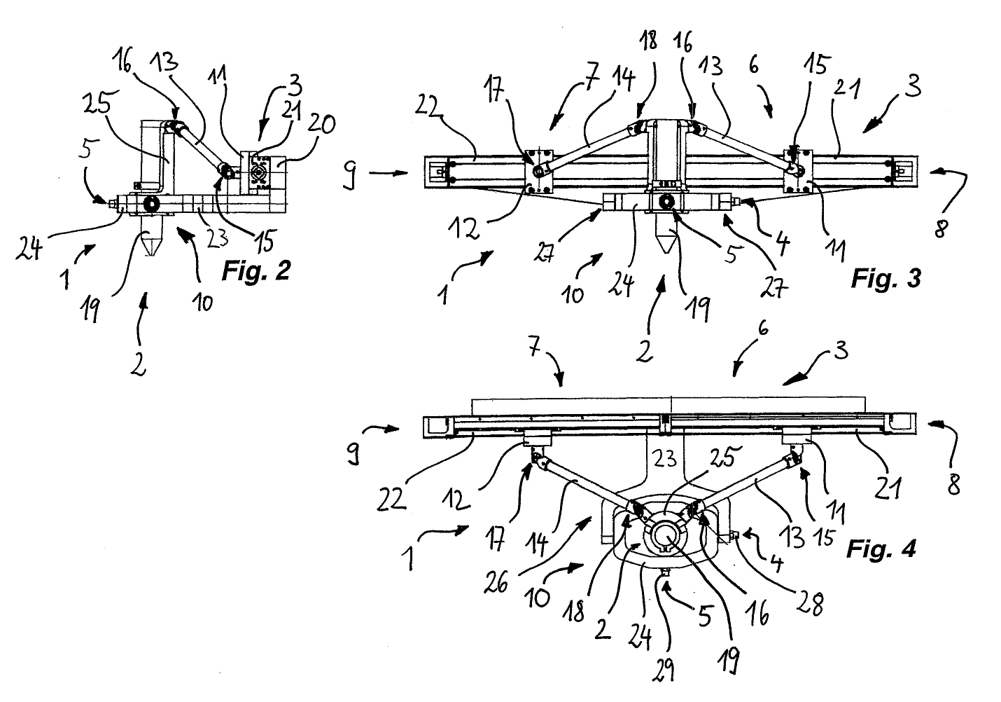

FIGS. 2, 3, and 4 show the cutting device 1 in the same operating position from the side, from the front, and from the top.

The cutting device 1 can be used particularly for cutting work pieces, in FIG. 1 clamped for processing underneath the cutting device 1.

The work pieces are clamped in a work piece receiver, not shown in greater detail, characterized in a horizontal work area.

The cutting device 1 has a cutting head 2, by which the separating processing can be executed. In order to largely allow cutting arbitrary shapes from the clamped work piece the cutting head 2 can be freely pivoted within a dihedral angle range. For the sake of clarity the supply lines for operating the cutting head 2 are not shown in greater detail. The cutting head 2 is arranged above the work piece clamped for processing.

The operating position in FIGS. 1 through 4 is therefore characterized in a vertical alignment of the cutting head 2.

A control device 3 causes the adjustment of the alignment of the operating direction of the cutting head 2 within the dihedral angle range.

In order to allow the mobility of the cutting head 2 within the dihedral angle range, the cutting head 2 is suspended in a pivotal fashion.

The suspension is implemented by two axes 4, 5 extending intersecting each other, each respectively allowing the cutting head 2 to pivot around one of said pivotal axes 4, 5. By combining these pivotal motions a pivoting can be performed around any arbitrary pivotal axis, located in the virtual plane defined by the axes 4 and 5.

The pivotal axes 4, 5 define a horizontal plane.

The control device 3 of the cutting device 1 has two actuators 6, 7 to perform the pivotal motions. These actuators 6, 7 can be operated independently from each other. The actuator 6 can be displaced guided along a linear axis 8, while the actuator 7 can be displaced along a linear axis 9.

Both actuators 6, 7 engage the cutting head 2, allowing the execution of a pivoting of the cutting head 2 within a dihedral angle range.

The cutting head 2 is suspended from the axes 4, 5, that form joints with precisely two degrees of freedom. The axis 4 intersects the axis 5 at a right angle, and the axis 5 is entrained when a motion occurs around the axis 4, so that overall a Cardan joint 10 is formed, in which the cutting head 2 is suspended.

The linear axes 8 and 9 extend in a straight line and are aligned parallel in reference to each other. As discernible from FIG. 1, in this embodiment the axes 8 and 9 are even embodied aligned with each other, thus they are positioned on a common, horizontally extending straight line.

Each actuator 6, 7 comprise a displaceable slide 11, 12. The slide 11 can be displaced along the linear axis 8, the slide 12 along the linear axis 9.

The slide 11 is connected to the cutting head 2 via a passive rod 13. The slide 12 is connected to the cutting head 2 via a passive rod 14. Therefore, the actuator 6 engages the cutting head 2 via the rod 13 having a fixed length and the actuator 7 via the rod 14 having a fixed length.

The rod 13 is linked via a link 15 to the slide 11 and via a link 16 to the cutting head 2. This way, the slide 11 is linked to the cutting head 2 in an articulated fashion. Similarly, the slide 12 is connected in an articulate fashion via a link 17 to the rod 14 and said rod 14 via a link 18 to the cutting head 2.

The links 15, 16, 17, and 18 are embodied as Cardan joints or universal joints to allow maximum mobility of the articulate connection.

The actuators 6 and 7 each comprise an electric drive, not shown in greater detail, here, by which the adjustment movement of the respective actuator 6 and 7 can be performed, i.e. the movement of the slides 11 and/or 12. The electric drives are not entrained during this adjustment motion, particularly their cable feeds are not stressed by these adjustment motions.

Additionally, a potentially existing cable supply to the cutting head 2 is not stressed for torque by supply lines for its operation because the cutting head 2 is pivoted and is not rotated around its longitudinal axis defined by the operating direction.

In order to perform the separating process the cutting head 2 comprises a plasma cutter 19 for plasma cutting. Alternatively or additionally, means are also provided for a laser cutter, jet cutter, and/or a mechanical cutter or the cutting device 19 can be exchanged for the above-mentioned types of cutters or the above-mentioned cutting devices can be integrated in the cutting head 2 or can be combined there.

Additionally, the cutting device 1 has a control unit, not shown. Said control unit comprises a computing unit for calculating the position of displacement of the actuators 6, 7 for a predetermined angular alignment of the cutting head 2 within the dihedral angle range.

Through the use of the Cardan suspension 10 and the length of the displacement path of the slides 11, 12 along the axes 8, 9, the opening angle of the maximally accessible dihedral angle range amounts to at least 90°. In the present case, the opening angle amounts to 94°, however larger opening angles, for example 96°, can also be achieved by adjusting the rods 13, 14 and the linear axes 8, 9. In general, the opening angle is smaller than 180°, though, due to the need for space for the Cardan suspension 10, for example smaller than 110°.

In the idle position, the cutting head 2 is arranged in the central axis of the opening angle and is symmetrically pivotal to all spatial directions by the same maximal angular amount.

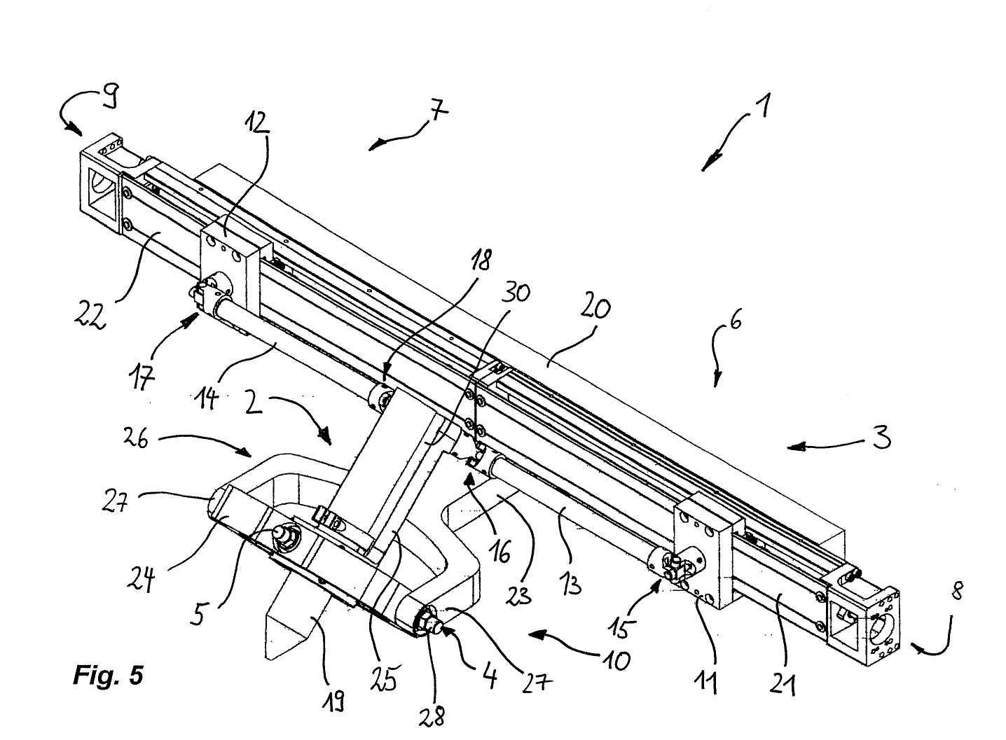

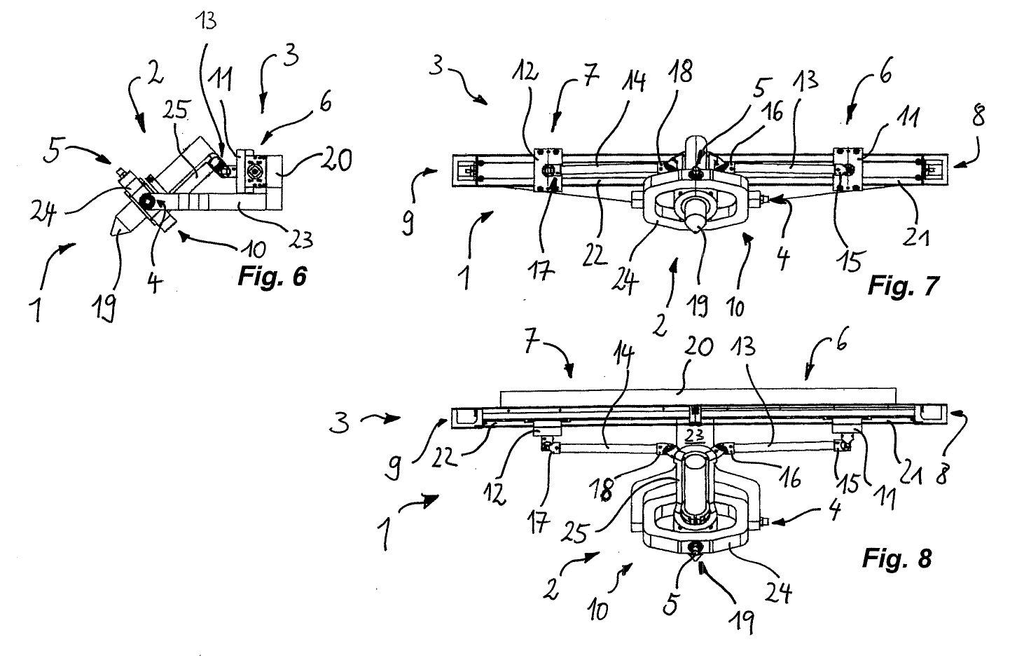

FIGS. 5 through 8 show the cutting device 1 according to FIGS. 1 to 4 in another operating position. Here, and in the subsequent figures the same components of the cutting device 1 are marked with the same reference characters and are not described separately, once more.

This operating position is characterized in a cutting head 2, aligned diagonally towards the front, discernible by the direction of the tip of the plasma cutter 19.

In this operational position, the rods 13 and 14 are aligned parallel in reference to the axes 8 and 9 as discernible from FIGS. 7 and 8. For this purpose, the slides 11 and 12 have been displaced opposite each other in reference to their positions in FIGS. 1 through 4, ergo away from each other. Therefore the operating position shown represents the maximum incline of the cutting head 2 towards the front and thus defines the limit of the accessible dihedral angle range, i.e. the opening angle in one direction.

From FIGS. 1 through 8 it is discernible from the changes of the positions of the rods 13 and 14 that pivoting the cutting head 2 around the axis 4 of the Cardan join 10 of the cutting head 2 can be executed by an opposite displacement of the actuators 6, 7 and thus the slides away from each other or towards each other.

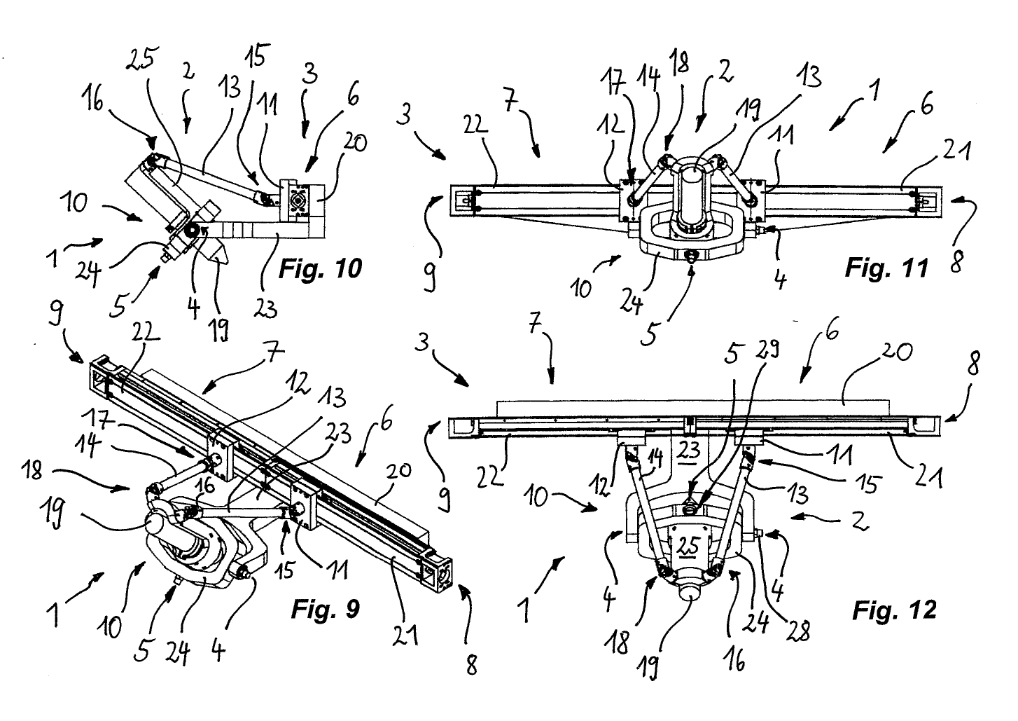

FIGS. 9 through 12 show the cutting device 1 according to FIGS. 1 through 4 in another operating position.

In order to reach this operating position of the cutting head 2 the slides 11 and 12 were displaced towards each other. In the displaced position shown, the slides 11 and 12 have reached the inner end of the displacement path of the linear axes 8 and/or 9. Accordingly, the accessible dihedral angle range is defined in this direction by the resulting incline of the cutting head 2 towards the rear.

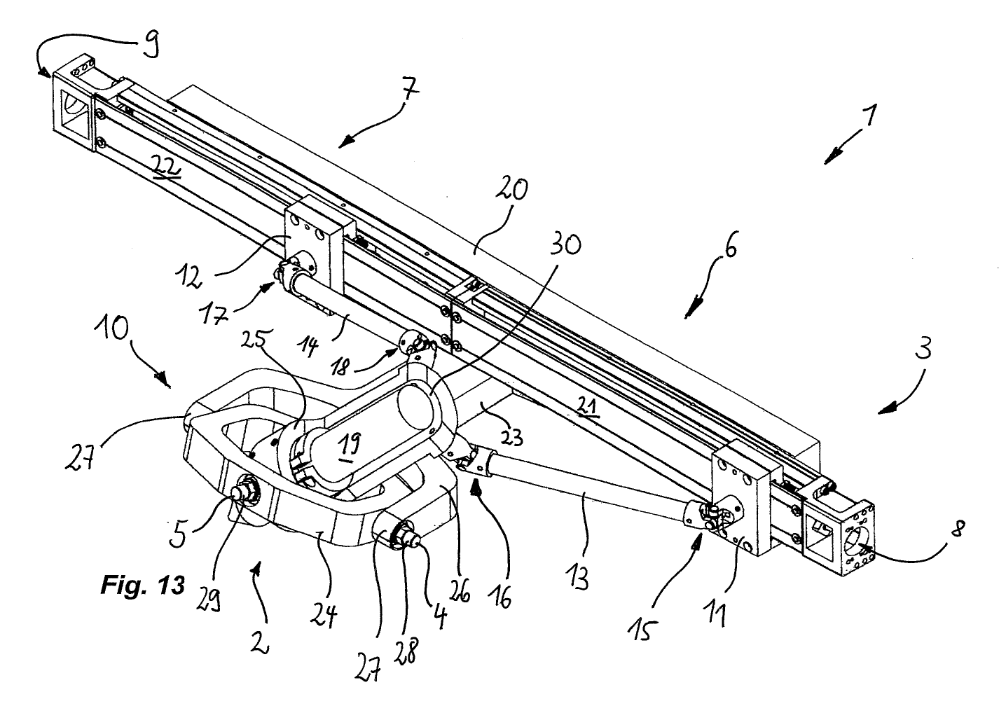

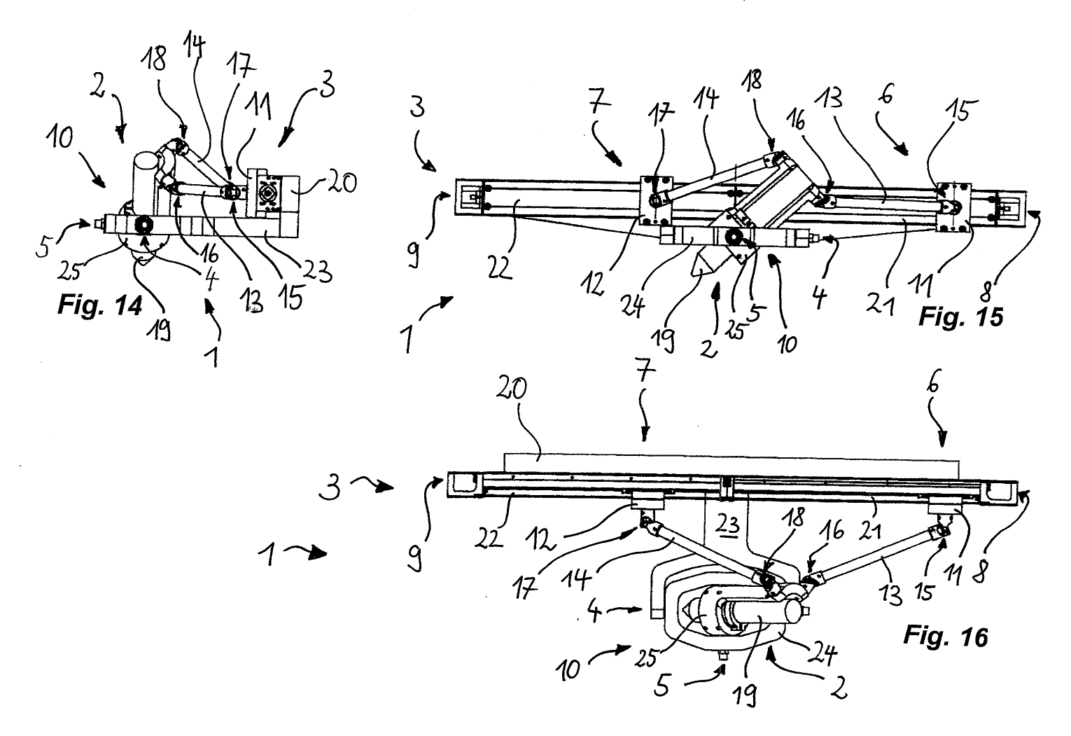

FIGS. 13 through 16 show the cutting device 1 according to FIGS. 1 through 4 in a fourth operating position.

In order to reach this operating position the slides 11 and 12 are displaced co-rotating, i.e. in the same direction. The slide 11 has therefore been displaced to the outer end of the displacement path of the linear axis 8, while the slide 12 is positioned at the inner end of the displacement path of the linear axis 9. This results in a maximum lateral incline of the cutting head 2, by which the accessible dihedral angle range is defined in this direction.

It is discernible that pivoting the cutting head 2 around the axis 5 in the suspension 10 of the cutting head 2 by a co-rotational displacement of the actuators 6 and 7 has been performed, i.e. displacing the slides 11 and 12 in the same direction. This way the cutting head is pivoted in a plane positioned perpendicularly in reference to the axis 5.

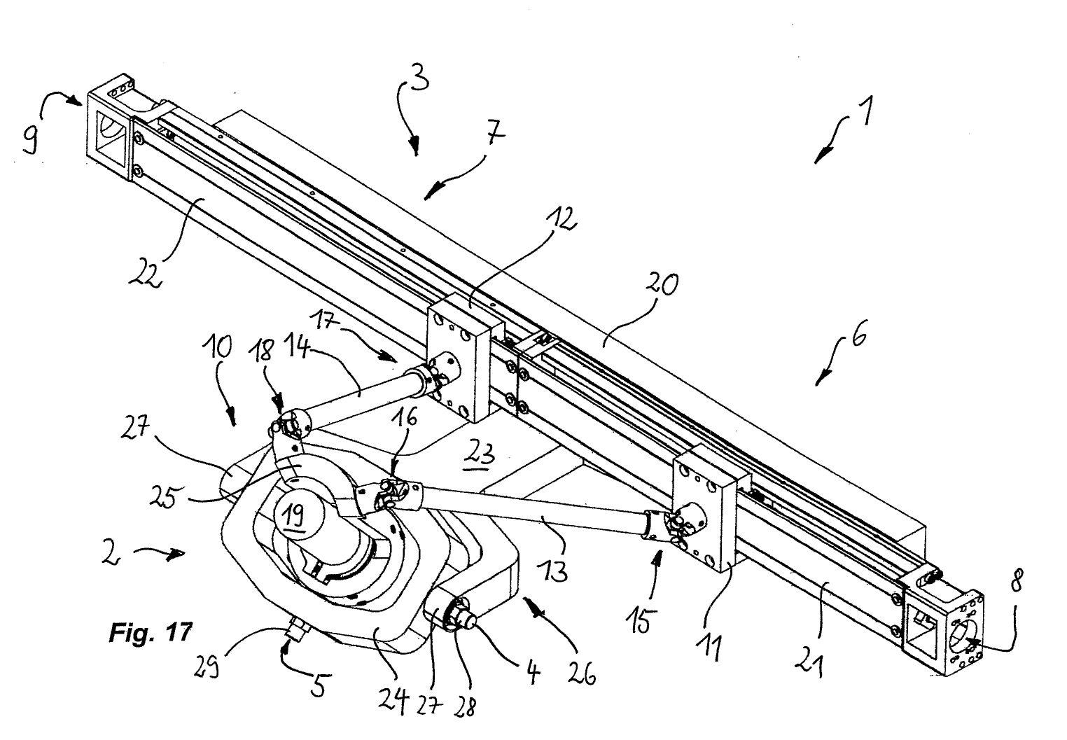

It is discernible from FIG. 17 that by combining opposite and co-rotating displacements of the slides 11 and 12 arbitrary inclined positions and displacement movements of the cutting head 2 can be adjusted and/or executed within the accessible dihedral angle range. In the operating position shown in FIG. 17, for example, the slide 12 is arranged at the interior end of the displacement path of the linear axis 9, while the slide 11 is arranged in the center of the displacement path of the linear axis 8. This results in a direction of operation, enforced by the rods 13 and 14, diagonally towards the back and diagonally towards the bottom left of the cutting head 2.

The cutting head 2 can be operated during the pivotal motion and/or at the end points of the pivotal motion.

The actuators 6 and 7 are fixed at a common mounting 20. The Cardan joint 10 of the cutting head 2 is connected to the mounting 20 of the control device 3 in a fixed manner. This connection is realized by a receiver 23.

The receiver 23 opens in a fork-shaped suspension 26, with the link of the axis 4 being arranged at its end. This link of the axis 4 is connected at two sides to a ring-shaped insert 24, on which the connection for the axis 5 is formed. Thus, at the ring-shaped insert 24, pins 28 are formed at two opposite sides, engaging rotary bearings which are formed at the ends 27 of the fork-shaped suspension 26. This way, the link of the axis 4 is formed. Similarly, two pins 29 are arranged at two opposite sides of the holder 25 engaging rotary bearings, which are embodied at the ring-shaped insert 24. This way the link of the axis 5 is formed. Therefore, the holder 25 for the plasma cutter 19 is connected at two sides to said link for the axis 5, so that overall a Cardan joint 10 is embodied for the holder 25. The links are embodied as rotary links. The rods 13, 14 are linked to the holder 25.

The receiver 23 with the fork-shaped suspension 26 projects from a vertical plane, in which the linear axes 8, 9 extend, at an angle and is aligned horizontally.

The holder 25 has a groove-shaped receiver 30, in FIG. 1 oriented vertically, for the plasma cutter 19 and/or a jet cutter, laser cutter, and/or a mechanical cutter, into which the respective cutters can be inserted.

It is not shown in the figures that the cutting device 1 with the Cardan suspension 10 of the cutting head 2 is displaceable in reference to a receiver or clamping device for the work piece. This displacement can be executed in a virtual plane, aligned horizontally in the figures, in order to reach all areas of the clamped work piece. This displacement plane is therefore aligned to the surface of the clamped work piece.

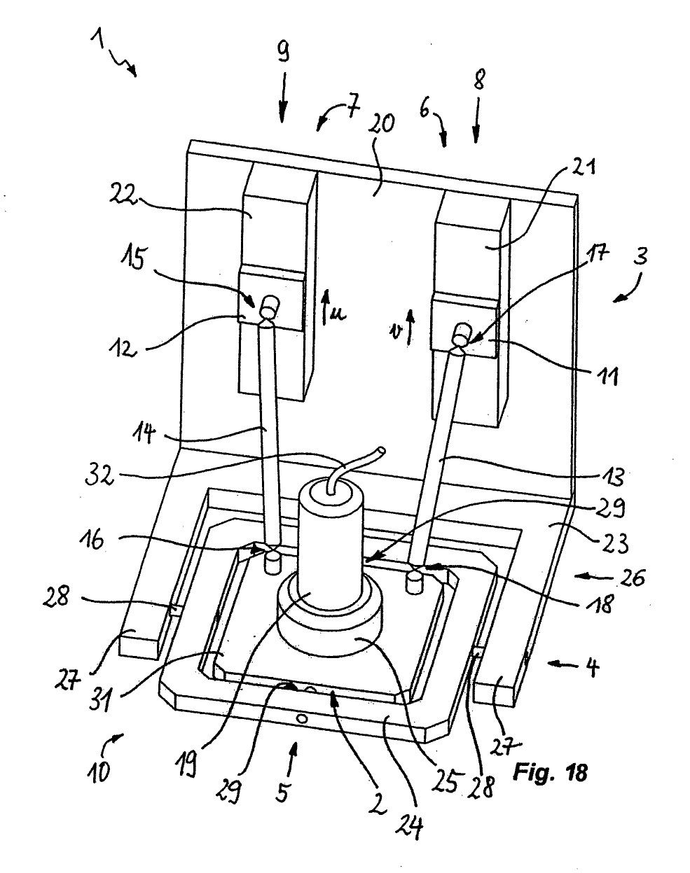

The three-dimensional side view of the cutting device 1 shown in FIG. 18 comprises a cutting head 2, pivotal within the dihedral angle range, similar to the cutting device according to FIGS. 1 through 17. In FIG. 18, parts functionally embodied similarly or identically to parts of the cutting device according to FIGS. 1 through 17 are marked with the same reference characters as in FIGS. 1 through 17. The explanations concerning the above-described exemplary embodiment are therefore respectively applicable here, too.

The cutting head 2 is suspended via two axes 4, 5, extending in a horizontal plane and aligned perpendicularly in reference to each other, in a fork-shaped suspension 26 of a receiver 23.

This way, a Cardan suspension 10 is formed, allowing a free alignment of the direction of operation of the cutting head 2 within the dihedral angle range. Therefore, the Cardan joint 10 has a ring 24 with a square basic shape and faceted edges, supported via pins 28 at the ends 27 of the fork-shaped suspension 26, pivotal around the axis 4. The plate 31 is inserted into the ring 24 and supported in the ring 24 via pins 29, pivotal around the axis 5.

On the plate 31 at which the holder 25 is formed as a sheath, the cutting head 2 carries a cutter or cutting device 19 inserted into said holder 25. The sheath-formed holder 25 forms therefore a receiver 30 for the cutter 19.

A cable 31 for supplying the operating means and energy to the cutter 19 is indicated at the cutter 19 for operating the cutting head 2.

Rods 13, 14 engage the plate 31 via links 16, 18, each of them linked at their ends, projecting from the plate 31 to one slide 11, 12 each via links 15, 17.

The slides 11, 12 can be displaced on straight rails 21, 22 and can be adjusted independently by actuators 6, 7 along linear axes predetermined by the rails 21, 22. This way a control device 3 is formed for the alignment of the cutting head 2.

By a co-rotational displacement of the actuators 6, 7, indicated by the arrows u, v in FIG. 8, the cutting head 2 is pivoted around the axis 8. By an opposite displacement of the actuators 6, 7, in which the displacement path of the slide 11, 12 is aligned at one actuator 6, 7 in the direction of the respective arrow u, v and at the other actuator 6, 7 in the opposite direction, against the respective arrow u, v, a rotation of the cutting head 2 with the plate 31 is caused around the axis 5. The control and the implementation of the rotary motion occurs as described in the above-mentioned exemplary embodiment.

The linear axes 8, 9 are vertically aligned in the operational position of the cutting device 1 shown in FIG. 18 and are located in a common plane. This plane is parallel in reference to the holder 20 of the control device embodied as a plate.

The linear axes 8, 9 are therefore parallel in reference to the central axis of the dihedral angle range open towards the bottom in FIG. 18 and therefore parallel in reference to the operating direction of the cutting head 2 in its central position with regard to the pivotal range.

The receiver 23 projects at an angle from the plane defined by the linear axes 8, 9 and thus protrudes towards the front beyond the control device 3. The plane predetermined by the receiver 23 and the plane described by the plate-shaped mounting 20 therefore enclose a right angle.

Due to the projection of the receiver 23 of the Cardan joint 10 in reference to the holder 20, the rods 13, 14 extend diagonally in reference to the horizontal and the vertical direction in all adjustment positions.

In order to execute the method according to the invention for controlling the cutting device 1, the displacement position of the slides 11, 12 on the respective linear axis 8, 9 of the actuators 6, 7 is calculated in a control and processing unit, not shown in greater detail, for a desired angular alignment of the cutting head 2 within the dihedral angle range.

The connection between the displacement path of the actuators 6, 7, i.e. the displacement positions of the slides 11, 12, and the resulting displacement angle of the cutting head 2 is not linear. This connection is stored in a processing unit in the form of a table or as a formula-based dependence.

In the cutting device 1, a cutting head 2 is pivotally suspended in a suspended link 10 having two intersecting or skew rotational axes 4, 5. Two actuators 6 and 7 engage the cutting head 2 via rods 13 and 14, which actuators are displaceable along linear axes 8 and 9 preferably aligned horizontally or vertically or diagonally. The adjusting movements around the axes 4 and 5 can be executed and controlled by the linearly adjusting movements of the actuators 6 and 7. The cutting head 2 has a plasma cutter 19 for plasma cutting and/or a laser cutter and/or a jet cutter and/or mechanical cutter.

1. A cutting device for cutting work pieces comprising: a cutting head (2) freely pivotal within a dihedral angle range and a control device (3), by which an alignment of an operating direction of the cutting head (2) can be adjusted within the dihedral angle range, the cutting head (2) is suspended in a pivotal fashion, and is pivotable about two axes (4, 5) that extend intersecting or skew in reference to each other, and the control device (3) comprises at least two actuators (6, 7) that can be operated independently from each other, each of the actuators being displaceable along a linear axis (8, 9) and each of the actuators engaging the cutting head (2) for pivoting the cutting head (2).

2. A cutting device according to claim 1, wherein the cutting head (2) is suspended in a Cardan joint (10).

3. A cutting device according to claim 1, wherein the linear axes (8, 9) extend in a straight fashion.

4. A cutting device according to claim 1, wherein the linear axes (8, 9) of the actuators (6, 7) are aligned at least one of parallel, side-by-side, or diagonally in reference to each other.

5. A cutting device according to claim 1, wherein the linear axes (8, 9) are arranged in a common plane.

6. A cutting device according to claim 5, wherein the common plane described by the axes (4, 5) of the suspension of the cutting head (2) is aligned horizontally in an operating position of the cutting device (1).

7. A cutting device according to claim 5, wherein in an operating position of the cutting device (1) the linear axes (8, 9) and a horizontal plane respectively enclose an angle.

8. A cutting device according to claim 5, wherein the linear axes (8, 9) are aligned vertically in an operating position of the cutting device (1).

9. A cutting device according to claim 1, wherein the linear axes (8, 9) are aligned at an acute angle or parallel in reference to an operating direction of the cutting head (2) in a central position thereof with reference to a potential pivoting and/or the linear axes (8, 9) are aligned in an acute angle or parallel in reference to a central axis of the dihedral angle range.

10. A cutting device according to claim 1, wherein the cutting head (2) is suspended in a fork-shaped receiver (23), which projects at an angle from a plane described by the linear axes (8, 9).

11. A cutting device according to claim 1, wherein each of the actuators (6, 7) comprises a slide (11, 12) displaceable along the linear axis (8, 9).

12. A cutting device according to claim 11, wherein each of the slides (11, 12) is connected in a linked fashion via rods (13, 14) that have a fixed length to the cutting head (2).

13. A cutting device according to claim 11, wherein the actuators (6, 7) each comprise an electric drive.

14. A cutting device according to claim 1, wherein the cutting head (2) comprises at least one of a plasma cutter (19), laser cutter, jet cutter, or mechanical cutter.

15. A cutting device according to claim 1, wherein a control unit is provided, embodied to calculate a displacement path of the actuators (6, 7) for a predetermined angular alignment of the cutting head (2) within the dihedral angle range.

16. A cutting device according to claim 15, wherein an opening angle of the dihedral angle range amounts to at least 90°.

17. A cutting device according to claim 16, wherein in the idle position the cutting head (2) is arranged in a central axis of the opening angle.

18. A cutting device according to claim 1, wherein pivoting the cutting head (2) around a first axis (4) of a suspension (10) of the cutting head (2) can be executed by an opposite displacement of the actuators (6, 7).

19. A cutting device according to claim 1, wherein pivoting the cutting head (2) around a second axis (5) of a suspension (10) of the cutting head (2) can be executed by a co-directional displacement of the actuators (6, 7).

20. A cutting device according to claim 1, wherein a suspension (10) of the cutting head (2) is connected in a fixed manner to a holder (20) of the control device (3).

21. A cutting device according to claim 1, wherein a suspension (10) of the cutting head (2) is displaceable in reference to the receiver for the work piece.

22. A method for controlling a cutting device, with the cutting device (1) comprising: a cutting head (2) freely pivotal within a dihedral angle range and a control device (3), by which an alignment of an operating direction of the cutting head (2) can be adjusted within the dihedral angle range, the cutting head (2) is suspended in a pivotal fashion, and is pivotable about two axes (4, 5) that extend intersecting or skew in reference to each other, and the control device (3) comprises at least two actuators (6, 7) that can be operated independently from each other, each of the actuators being displaceable along a linear axis (8, 9) and each of the actuators engaging the cutting head (2) for pivoting the cutting head (2), the method comprising operating the two actuators (6, 7) independently from each other are each displaced along the corresponding linear axis (8, 9) to execute a pivotal motion of the cutting head (2).

23. A method according to the claim 22, further comprising calculating a displacement position on the respective linear axis (8, 9) of the actuators (6, 7) in a computer for a predetermined angular alignment of the cutting head (2) within the dihedral angle range.

24. A method according to claim 22, wherein a connection between a displacement path of the actuators (6, 7) and the resulting pivotal angle of the cutting head (2) is not linear.
